(19) United States
(12) Patent Application Publication
(10) Pub. No.: US 2013/0159899 A1
(43) Pub. Date: Jun. 20, 2013

(54) DISPLAY OF GRAPHICAL REPRESENTATIONS

(71) Applicants: Erich Jose Martino Peña, London (GB); Joseph Phillips, London (GB)

(72) Inventors: Erich Jose Martino Peña, London (GB); Joseph Phillips, London (GB)

(73) Assignee: NOKIA CORPORATION, Espoo (FI)

(21) Appl. No.: 13/328,487

(22) Filed: Dec. 16, 2011

(51) Int. Cl. G06F 3/048

(52) U.S. Cl. 715/765

(57) ABSTRACT

Methods, apparatuses, and computer program products are herein provided for improved display of graphical representations during reordering. A method may include receiving user input directed at a first graphical representation on a display. The method may further include causing, by a processor, enlargement in size of the first graphical representation on the display in response to receiving the user input. The method may further include causing reduction in size of at least a second graphical representation on the display in response to receiving the user input, wherein at least one of the at least one second graphical representation is displayed adjacent to the first graphical representation. Corresponding apparatuses and computer program products are also provided.

### TECHNOLOGICAL FIELD

Example embodiments of the present invention relate generally to user interface technology and, more particularly, relate to methods, apparatuses, and computer program products for improved display of graphical representations, such as during reordering of graphical representations.

### BACKGROUND

The modem communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modem networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

Increased functionality of mobile computing devices has enabled mobile computing devices to store and perform many functions (e.g., applications, documents, media files, pictures, etc.). Additionally, mobile computing devices have developed display formats that show graphical representations (e.g., icons) of these functions. An example display format for graphical representations of applications is often referred to as a homescreen.

### BRIEF SUMMARY

Embodiments of the present invention provide methods, apparatuses, and computer program products for improved display of graphical representations during reordering. In one example embodiment, a method includes receiving user input directed at a first graphical representation on a display. The method further includes causing, by a processor, enlargement in size of the first graphical representation on the display in response to receiving the user input. The method further includes causing reduction in size of at least a second graphical representation on the display in response to receiving the user input, wherein at least one of the at least one second graphical representation is displayed adjacent to the first graphical representation.

In another example embodiment, an apparatus comprising at least one processor and at least one memory storing computer program code, wherein the at least one memory and stored computer program code are configured, with the at least one processor, to cause the apparatus to receive user input directed at a first graphical representation on a display. The at least one memory and stored computer program code are configured, with the at least one processor, to further cause enlargement in size of the first graphical representation on the display in response to receiving the user input. The at least one memory and stored computer program code are configured, with the at least one processor, to further cause reduction in size of at least a second graphical representation on the display in response to receiving the user input, wherein at least one of the at least one second graphical representation is displayed adjacent to the first graphical representation.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method comprising receiving user input directed at a first graphical representation on a display. The method further includes causing enlargement in size of the first graphical representation on the display in response to receiving the user input. The method further includes causing reduction in size of at least a second graphical representation on the display in response to receiving the user input, wherein at least one of the at least one second graphical representation is displayed adjacent to the first graphical representation.

In another example embodiment, an apparatus is provided. The apparatus comprises means for receiving user input directed at a first graphical representation on a display. The apparatus further includes a means for causing enlargement in size of the first graphical representation on the display in response to receiving the user input. The apparatus further includes a means for causing reduction in size of at least a second graphical representation on the display in response to receiving the user input, wherein at least one of the at least one second graphical representation is displayed adjacent to the first graphical representation.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus with a user interface according to an example embodiment;

FIG. 2 is a schematic block diagram of a mobile terminal according to an example embodiment;

FIGS. 3A-3B illustrate example user inputs (e.g., gestures) indicating desired operation of a function on an apparatus, such as the apparatus illustrated in FIG. 1, in accordance with example embodiments described herein;

FIG. 4 illustrates an example display for an apparatus, such as the apparatus illustrated in FIG. 1, wherein the display includes graphical representations of applications for the apparatus, in accordance with example embodiments described herein;

FIG. 5 illustrates another example display for an apparatus, such as the apparatus illustrated in FIG. 1, wherein the display includes graphical representations arranged in alphabetical order (e.g., “A”-“T”), in accordance with example embodiments described herein;

FIG. 6 illustrates the apparatus illustrated in FIG. 5, wherein a user selects a graphical representation “G”, in accordance with example embodiments described herein;

FIG. 6A illustrates the apparatus illustrated in FIG. 6, wherein the graphical representation “G” is enlarged in size, in accordance with example embodiments described herein;

FIG. 6B illustrates the apparatus illustrated in FIG. 6, wherein the graphical representation “G” is enlarged in size and some of the other graphical representations are reduced in size in an amount proportional to their distance away from graphical representation “G”, in accordance with example embodiments described herein;

FIG. 6C illustrates the apparatus illustrated in FIG. 6, wherein the graphical representation “G” is enlarged in size and some of the other graphical representations are reduced in size in an amount inversely proportional to their distance away from graphical representation “G”, in accordance with example embodiments described herein;

FIG. 7 illustrates the apparatus illustrated in FIG. 6, wherein the user has moved the graphical representation “G” toward a new position, in accordance with example embodiments described herein;

FIG. 7A illustrates the apparatus illustrated in FIG. 6, wherein the user has moved the graphical representation “G” into the new position, in accordance with example embodiments described herein;

FIG. 8 illustrates the apparatus illustrated in FIG. 6, wherein the user has released the graphical representation “G” into the new position, in accordance with example embodiments described herein;

FIG. 9 illustrates a flowchart according to an example method for improved display of graphical representations during reordering, in accordance with example embodiments described herein; and

FIG. 10 illustrates a flowchart according to another example method for improved display of graphical representations during reordering, in accordance with example embodiments described herein.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

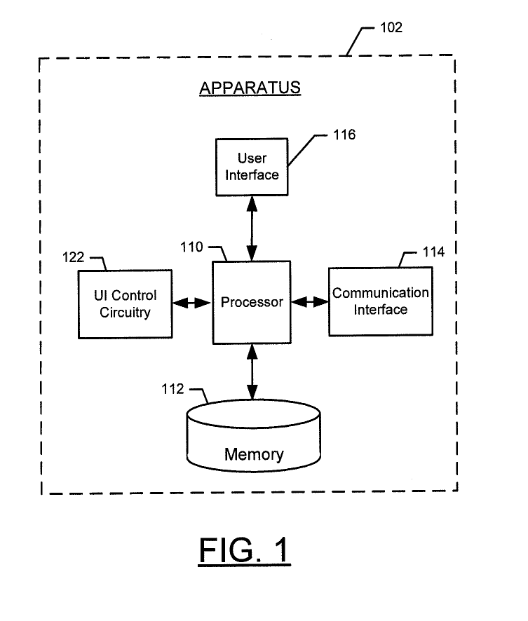

FIG. 1 illustrates a block diagram of an apparatus 102 for facilitating interaction with a user interface according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for facilitating interaction with a user interface, other configurations may also be used to implement embodiments of the present invention.

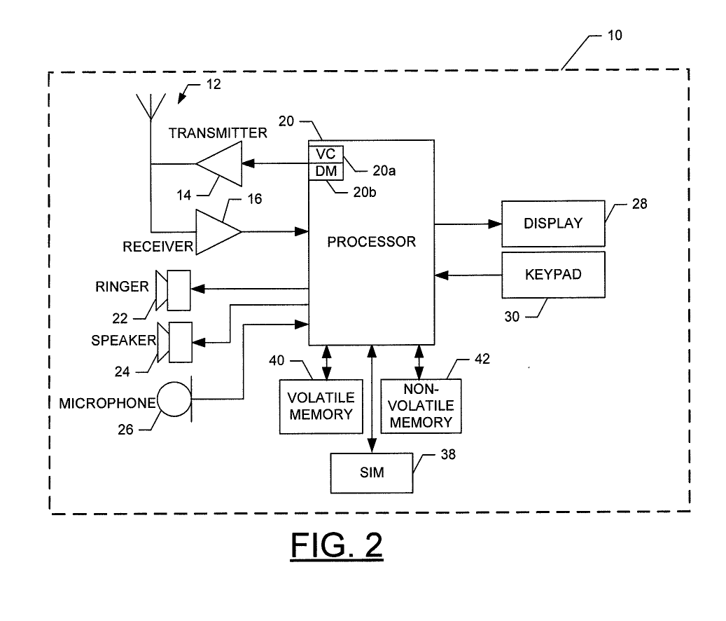

The apparatus 102 may be embodied as either a fixed device or a mobile device such as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a touch display capable of displaying a graphical user interface. In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, positioning devices, tablet computers, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs (e.g., applications), which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile terminal 10. Alternatively or additionally, the keypad 30 may include a conventional QWERTY keypad arrangement.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. The communication interface 114 may additionally be in communication with the memory 112, user interface 116, and/or UI control circuitry 122, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. In embodiments wherein the apparatus 102 is embodied as a mobile terminal 10, the user interface 116 may be embodied as or comprise the display 28 and keypad 30 (shown in FIG. 2). The user interface 116 may be in communication with the memory 112, communication interface 114, and/or UI control circuitry 122, such as via a bus.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive user input from a user interface 116, such as a touch display. The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine a position of the user input such as for determining a portion of the display to which the user input correlates.

The touch display may also be configured to enable the detection of a hovering gesture input. A hovering gesture input may comprise a gesture input to the touch display without making physical contact with a surface of the touch display, such as a gesture made in a space some distance above/in front of the surface of the touch display. As an example, the touch display may comprise a projected capacitive touch display, which may be configured to enable detection of capacitance of a finger or other input object by which a gesture may be made without physically contacting a display surface. As another example, the touch display may be configured to enable detection of a hovering gesture input through use of acoustic wave touch sensor technology, electromagnetic touch sensing technology, near field imaging technology, optical sensing technology, infrared proximity sensing technology, some combination thereof, or the like.

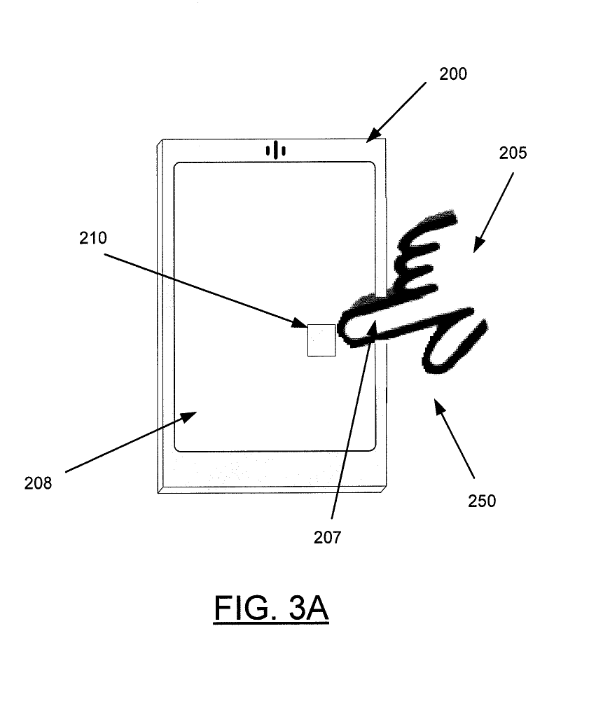

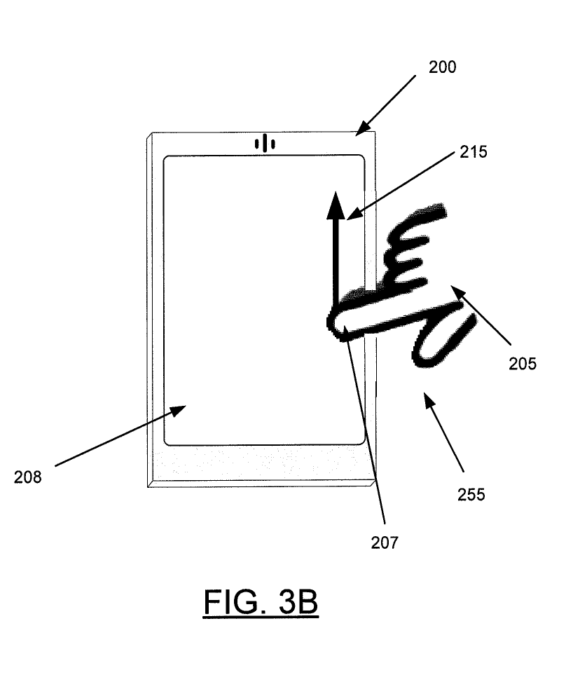

The processor 110 and/or UI control circuitry 122 may be configured to receive user input and/or an indication of user input. The user input may indicate a user's desire for the apparatus 102 to perform a designated function (e.g., run an application, load a website, move the location of a graphical representation on a display, etc.). In some embodiments, the different components and/or abilities of the apparatus 102 may determine the types of functions able to be performed. Some examples of gestures are shown in FIGS. 3A and 3B.

FIG. 3A illustrates an example user input 250 for an apparatus 200 with a touch display 208 (e.g., user interface 116). In the depicted embodiment, a user 205 positions their finger 207 on or near the display, and particularly, on or near a portion 210 of the display. In some embodiments, the portion 210 of the display may correspond to a pre-determined point that is associated with a desired function and/or corresponding graphical representation. In other words, the portion 210 may correlate to a function that can be performed by the apparatus 200 (e.g., an application). For example, the portion 210 may correlate to a graphical representation corresponding to an application that grants access to the internet. Likewise, the portion 210 may correlate to a graphical representation corresponding to another function, such as a media file, document, picture, etc. Thus, by placing a finger 207 on or near the portion 210 (e.g., “touching”), the user 205 is indicating a desire for the apparatus 200 to perform that related function (e.g., open the internet, access the linked website, launch the game application, open the media file, etc.). Based on the user input detected by the user interface 116, the processor 110 and/or UI control circuitry 122 may respond, causing performance of the desired function. In some embodiments, a pro-longed touching input (e.g., a touch input that maintains contact (or near contact) for a pre-determined amount of time) with the portion 210 may correspond to a user's desire to reorder and/or move the corresponding graphical representation on the display 208.

FIG. 3B illustrates another example user input 255, often referred to as a “swipe gesture”, for an apparatus 200 with a touch display 208 (e.g., user interface 116). In the depicted embodiment, a user 205 positions a finger 207 on or near a portion of the display. The user 205 may slide their finger 207 along the display 208 (e.g., along arrow 215). In some embodiments, a user may slide their finger in a generally linear direction to define a swipe gesture. This user input often corresponds to a user's desire to “scroll” or move the display to show displayed content that may be currently off the display. Based on the user input detected by the user interface 116, the processor 110 and/or UI control circuitry 122 may respond (e.g., scrolling the previously un-displayed content onto the display for the user). Though the above example details functionality of scrolling being correlated with a “swipe gesture”, such a gesture/input is not limited to functionality related to scrolling and, in some embodiments, such as some embodiments of the present invention, the “swipe gesture” may correspond to any type of functionality. For example, the processor 110 and/or UI control circuitry 122 may be configured to move a graphical representation on a display in response to receiving a “swipe gesture,” or an input similar to the swipe gesture.

As indicated above, there are many types of user inputs that are recognizable by apparatus 102. Some additional known user inputs include pinching or reverse pinching for zooming out or zooming in, respectively. Though the above description provides examples of typical user inputs, embodiments of the present invention can be utilized with any type of user input. In that same vein, though the above detailed user inputs are described with respect to a touch display, embodiments of the present invention may be utilized with an apparatus 102 that contains designated user input components, such as buttons or scroll bars.

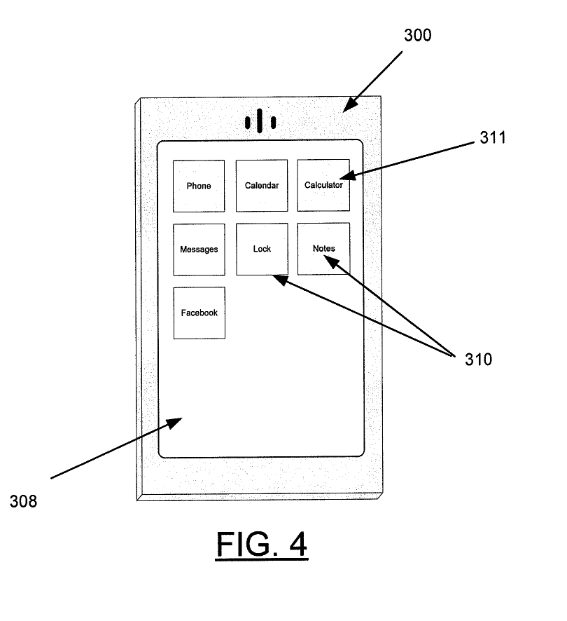

As noted herein, in some embodiments, the apparatus 102, including the processor 110 and/or UI control circuitry 122, may be configured to perform functionality, such as opening, running, and/or executing an application, media file, document, picture, or other function. In some embodiments, the apparatus 102 may be configured to display an arrangement of graphical representations (e.g., icons) that represent functions for which the apparatus 102 is configured to perform functionality for. For example, in some embodiments, apparatus 102 may be configured to display a “homescreen” that includes an arrangement of graphical representations of applications. With reference to FIG. 4, an example apparatus 300 (e.g., apparatus 102) comprises a display 308 (e.g., user interface 116) that is currently displaying a homescreen. In the depicted embodiment, the display 308 details graphical representations 310 that each correspond with an application (e.g., a notes application, a lock application, etc.). For example, a calculator graphical representation 311 corresponds to an application that includes functionality for performing mathematical calculations. Though the above described “homescreen” displays an arrangement of graphical representations of applications, in some embodiments, other graphical representations may be displayed in an arrangement on a display (e.g., user interface 116) of the apparatus (e.g., apparatus 102), such as graphical representations corresponding to documents, media files, pictures, etc.

Often apparatuses, such as apparatus 102, have a vast array of functionality, and as a result, have a large number of graphical representations that correspond to that functionality. Whether representing applications, document, media files, pictures, etc., the apparatus 102 may be configured to display the graphical representations in a pre-determined order within an arrangement. This pre-determined order may define an order based on any type of criteria (e.g., order in which the corresponding function was downloaded, alphabetical order, etc.).

The small form factor of mobile computing devices (e.g., apparatus 102), however, limits the number of graphical representations able to be displayed, which has led to customizable ordering of the graphical representations on the display. For instance, apparatuses, such as apparatus 102, are often personally owned and utilized by a specific user, and to further aid in ease of use, the user changes the order of the graphical representations. The result being a personalized ordering of the graphical representations that is tailored for the specific user. Such a personalized ordering is useful for a user that may develop a comfort with the location of certain graphical representations on the display (e.g., user interface 116). Customizable ordering (or reordering) to date, however, has been difficult for users, often resulting in an undesired ordering of the graphical representations due to errors in placement during the reordering process.

With limited space on the display and the importance of positioning for graphical representations, personalization of the order of the graphical representations is paramount for mobile computing devices. As such, as indicated above, a user may often wish to reorder the graphical representations on the display of the mobile computing device. However, the small size of the graphical representations (and the display) often leads to errors in targeting and repositioning of the graphical representations.

As such, embodiments of the present invention seek to provide an improved display of graphical representations during reordering so as to enhance a user's experience and limit potential for error in the process. For example, the mobile computing device may be configured to enlarge the size of a selected graphical representation and shrink the size of surrounding graphical representations to enable a user to more easily discern the targeted graphical representation. Additionally, in some embodiments, the mobile computing device may be configured to dynamically alter the sizes of graphical representations as the selected graphical representation is moved across the display toward its customized position. Further, in some embodiments, the mobile computing device may be configured to create a space on the display for easy positioning and placement of the selected graphical representation, thereby providing a user with a discernable preview of the final position of the selected graphical representation.

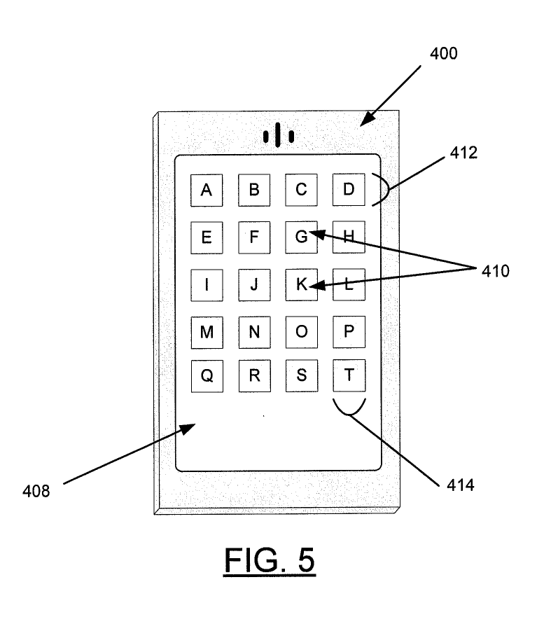

Thus, in some embodiments, the apparatus 102 may be configured to enable a user to reorder (e.g., rearrange) the placement of the graphical representations on the display. Additionally, embodiments of the present invention may be configured to cause an improved display of the graphical representations to aid the user during reordering of the graphical representations. FIGS. 5, 6, 6A-6C, 7, 7A, and 8 will be referenced herein for illustration of an example processes of reordering a graphical representation according to some embodiments of the present invention. The described embodiments, however, are not meant to limit embodiments of the present invention and are provided for explanatory purposes.

As noted above, in some embodiments, the apparatus 102 may be configured to cause display of at least one graphical representation on a user interface 116 (e.g., a display). In some embodiments, the apparatus 102 may be configured to cause display of more than one graphical representation in an arrangement. Additionally, in some embodiments, the apparatus 102 may be configured to display the graphical representations in an order (e.g., a pre-determined order). For example, FIG. 5 shows an apparatus 400 with a display 408. The display 408 details 16 graphical representations 410, labeled “A”-“T”, respectively. These graphical representations are displayed in a 5×4 arrangement (e.g., 5 rows 412 and 4 columns 414). Additionally, the graphical representations 410 are displayed in alphabetical order from left to right and top to bottom. As noted above, the graphical representations may correspond to certain functionality of the apparatus, such as applications, documents, media files, pictures, etc.

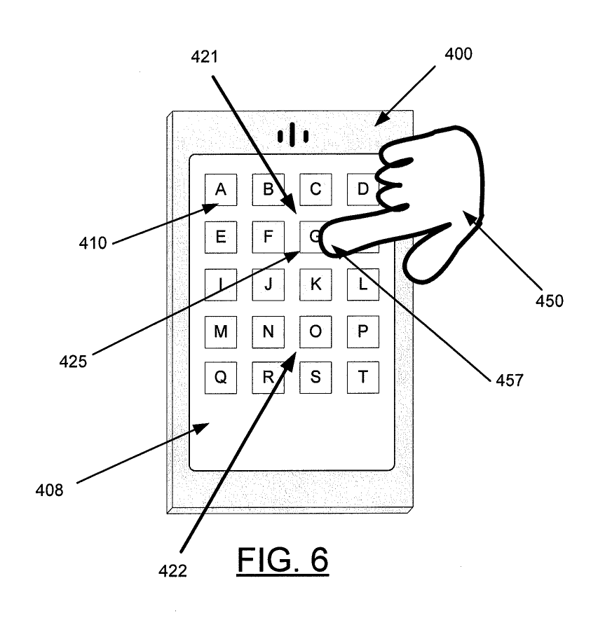

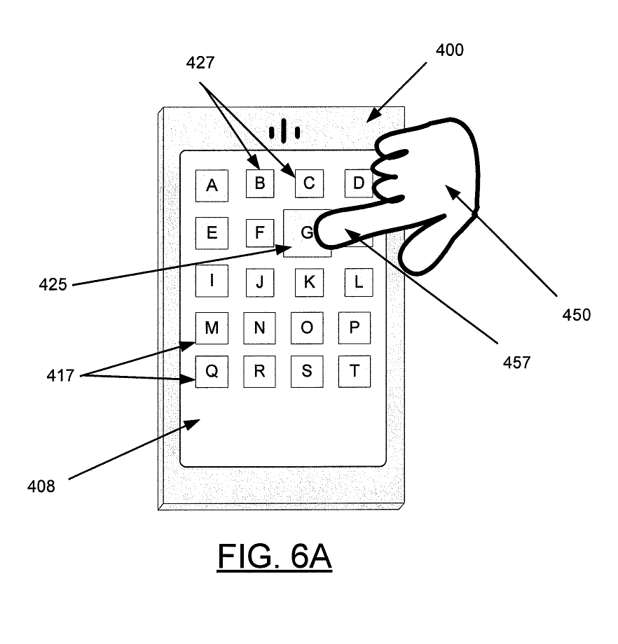

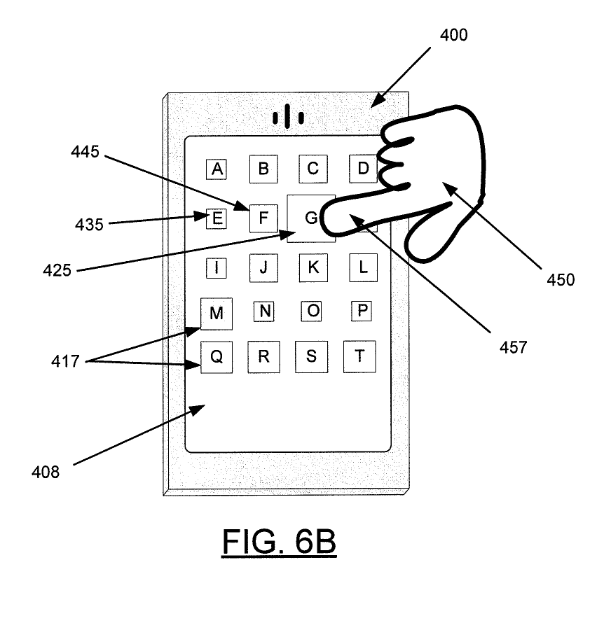

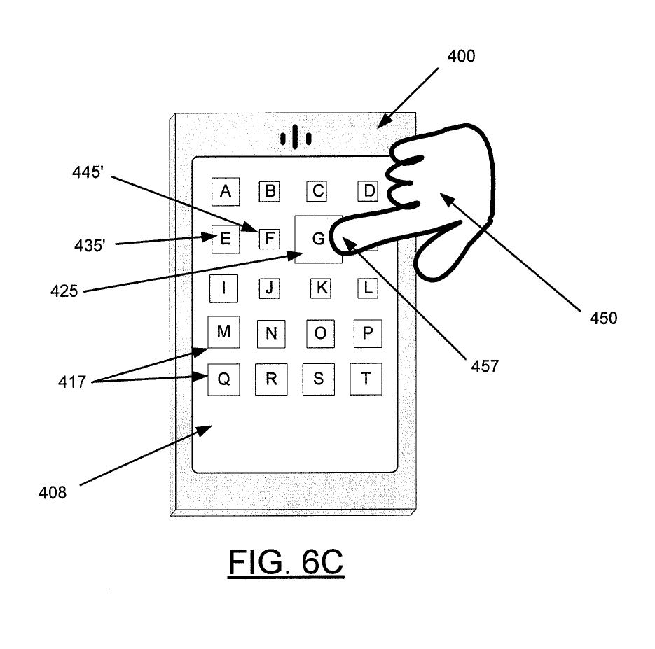

Often a user may wish to reorder the graphical representations on the display of the apparatus. As such, in some embodiments, a user may perform a user input (e.g., a pro-longed touch input) directed toward at least one of the graphical representations shown on the display of the apparatus 102. Such a user input may indicate the user's desire to reorder and/or move the targeted graphical representation on the display of the apparatus 102. For example, with reference to FIG. 6, a user 450, with their finger 457, provides input (e.g., a pro-longed touch input) directed at a first graphical representation (“G”) 425, among an arrangement of graphical representations 410. Such an input may indicate the user's desire to move the first graphical representation (“G”) 425 from a first position 421 to a second position 422 on the display 408. Though a pro-longed touch input is referenced above for indicating a desire to reorder and/or move the targeted graphical representation, in some embodiments, other inputs may be used.

As noted above, embodiments of the present invention provide improved display of graphical representations to aid a user in reordering the graphical representations. Considering the often small size of the display and correspondingly small size of each graphical representation, it may be difficult to accurately target and/or reposition graphical representations on the display. As such, in some embodiments, in response to receiving the user input that indicates a user's desire to reorder and/or move a graphical representation, the apparatus 102 may be configured to cause the display of at least one of the graphical representations to be altered, such as to aid in the reordering of the graphical representations. FIGS. 6A-6C illustrate some example alterations of graphical representations according to some embodiments of the present invention. Though these example embodiments detail specific alterations and/or combination of alterations, embodiments of the present invention are not meant to be limited to the below described alterations, or combination of alternations, and may include any type of alteration (or combination of alterations).

In some embodiments, the apparatus 102 may be configured to cause enlargement in size of at least one graphical representation in response to receiving the user input. In some embodiments, the apparatus 102 may be configured to cause enlargement in size of the first graphical representation (e.g., selected graphical representation). For example, with reference to FIG. 6A, the first graphical representation (“G”) 425 has been enlarged in size in comparison to its original size (shown in FIG. 5). Such enlarged size enables a user to more easily determine if the correct graphical representation was selected/targeted. Moreover, such enlargement enables easier manipulation (e.g., movement, dragging, etc.) of the first graphical representation, as will be described in greater detail herein.

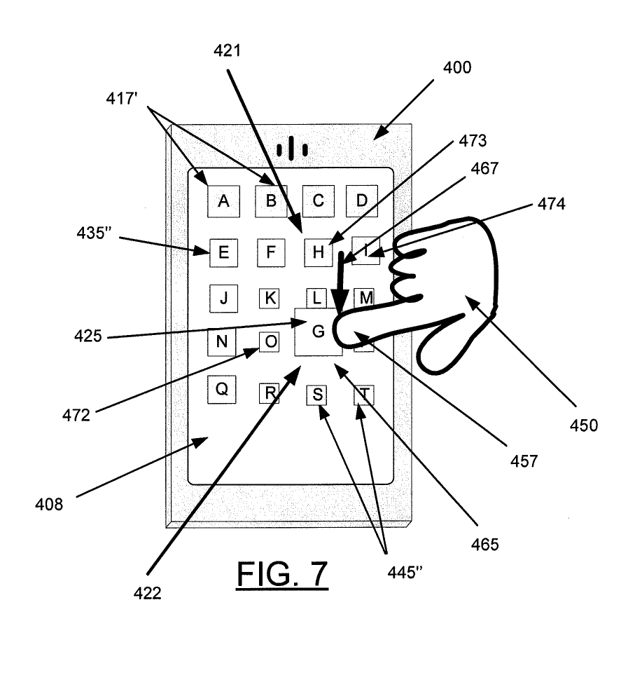

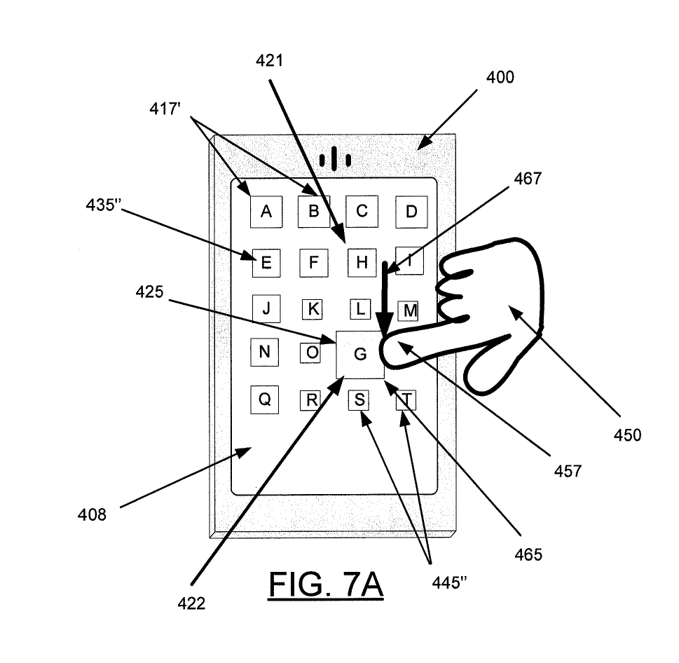

In some embodiments, the apparatus 102 may be configured cause reduction in size of at least one graphical representation in response to receiving the user input. In some embodiments, the apparatus 102 may be configured to cause reduction in size of at least one second graphical representation (e.g., a graphical representation other than the first graphical representation). In some embodiments, the at least one second graphical representation may be displayed adjacent to the first graphical representation. As used herein, “adjacent” may refer to a graphical representation being displayed as a neighboring graphical representation, such as within one row or one column of another graphical representation (or space or position, such as the second position shown in FIG. 7A and described in greater detail herein), and may not be limited to graphical representations that contact each other directly. For example, with reference to FIG. 5, graphical representations “B”-“D”, “F”, “H”, and “J”-“L” may each be considered adjacent to graphical representation “G”. Though in the above described example display adjacency of graphical representations is defined as neighboring rows and/or columns, other types of displays are contemplated for embodiments of the present invention (e.g., a circular display, a scattered display, etc.) and, thus, the determination of adjacency of graphical representations is not meant to be limited to row and/or column distinctions.

FIG. 6A illustrates and example embodiment where graphical representations “B”-“D”, “F”, “H”, and “J”-“L” 427 have been reduced in size from their original size (shown in FIG. 5). In the depicted embodiment, graphical representations “B”-“D”, “F”, “H”, and “J”-“L” are displayed adjacent to the first graphical representation “G” 425. Such reduction in size of these second graphical representations 427 provides additional space for the newly enlarged first graphical representation 425. Additionally, the reduction in size further accentuates the first graphical representation 425 to the user.

In some embodiments, the apparatus 102 may be configured to selectively reduce in size at least one second graphical representation such that not all of the currently displayed graphical representations may be reduced in size. In particular, in some embodiments, the apparatus 102 may be configured to determine which graphical representations to reduce in size. In some embodiments, the apparatus 102 may be configured to reduce in size the graphical representations that are displayed within a pre-determined distance (e.g., within a minimum threshold) from the first graphical representation (e.g., the graphical representation selected by the user). For example, with reference to FIG. 6A, the apparatus 400 has caused reduction in size in only the graphical representations “B”-“D”, “F”, “H”, and “J”-“K” 427 that are directly adjacent to the first graphical representation “G” 425. As such, the remaining graphical representations “A”, “E”, “I”, and “M”-“T” 417 have remained the size they were originally displayed as (shown in FIG. 5). Though the above description details a minimum threshold distance of being adjacent to the first graphical representation, other distances may be used by embodiments of the present invention.

In some embodiments, the apparatus 102 may be configured to determine the amount of reduction to cause to the size of the graphical representation. In some embodiments, the amount of reduction of the size of the graphical representation may be based on a characteristic of the graphical representation to be reduced. For example, in some embodiments, the amount of reduction in size of the graphical representation may be proportional to the distance the graphical representation is away from the first (e.g., selected) graphical representation. In some embodiments, the apparatus 102 may be configured to cause reduction in the size of at least one graphical representation in an amount based at least in part on the proportional distance on the display from the graphical representation to the first graphical representation (e.g., the selected graphical representation). For example, with reference to FIG. 6B, once the user 450 selects the first graphical representation “G” 425, the apparatus 400 may cause a first reduction in the size (e.g., slight reduction) of the graphical representations “B”-“D”, “F”, “H”, and “J”-“K” 445, which are directly adjacent to the first graphical representation “G” 425. Additionally, the apparatus 400 may cause a second reduction in the size (e.g., a larger reduction) of the graphical representations “A”, “E”, “I”, and “N”-“P” 435, which are a row or column removed from the graphical representations 445 that are directly adjacent to the first graphical representation “G” 425. Thus, the graphical representations 435 that received a larger reduction are further away in distance on the display from the first graphical representation “G” 425 than the graphical representations 445 that received a slight reduction, which are directly adjacent to the first graphical representation 415. Additionally, as noted herein, some of the graphical representations 417 may not be reduced in size from their original size, as they fall outside of the minimum threshold distance away from the first graphical representation “G” 425. Advantages of such an improved display allow for a user to more easily focus on the most likely graphical representations to be affected by any reordering (e.g., the graphical representations closest to the selected graphical representation).

In some embodiments, the apparatus 102 may be configured to cause reduction in the size of at least one graphical representation in an amount based at least in part on the inverse proportional distance on the display from the graphical representation to the first graphical representation (e.g., the selected graphical representation). For example, with reference to FIG. 6C, once the user 450 selects the first graphical representation “G” 425, the apparatus 400 may cause a first reduction in the size (e.g., large reduction) of the graphical representations “B”-“D”, “F”, “H”, and “J”-“K” 445′, which are directly adjacent to the first graphical representation “G” 425. Additionally, the apparatus 400 may cause a second reduction in the size (e.g., a slight reduction) of the graphical representations “A”, “E”, “I”, and “N”-“P” 435′, which are a row or column removed from the graphical representations 445′ that are directly adjacent to the first graphical representation “G” 425. Thus, the graphical representations 435′ that received a slight reduction are further away in distance on the display from the first graphical representation “G” 425 than the graphical representations 445′ that received a larger reduction, which are directly adjacent to the first graphical representation 425. Additionally, as with FIG. 6B, some of the graphical representations 417 may not be reduced in size from their original size, as they fall outside of the minimum threshold distance away from the first graphical representation “G” 425. Advantages of such an improved display allow for a user to more easily focus on the selected graphical representation and the corresponding position of the selected graphical representation, which will be described in greater detail herein.

Accurate movement and positioning of the first (e.g., selected) graphical representation can be difficult for a user. In particular, a user may be unsure of exactly where the selected graphical representation will be positioned upon completion of the move (e.g., release of the user input). As such, embodiments of the present invention seek to improve display of the arrangement of the graphical representations during movement and positioning of the selected graphical representation.

In some embodiments, the apparatus 102 may be configured to receive a second user input indicating a desire to move the first graphical representation on the display. An example user input can be a drag or swipe gesture (shown in FIG. 3B), such as starting at one point on the display and ending at another point. As such, in some embodiments, the second user input may indicate a desired change in position of the first graphical representation from a first position to a second position. For example, with reference to FIG. 7, a user 450 may perform user input (e.g., a drag/swipe gesture) with their finger 457 on the display 408. The user input may indicate a desired change in the displayed location of the first graphical representation “G” 425 from a first position 421 to a second position 422 (such as along arrow 467).

In some embodiments, in response to receiving the second user input, the apparatus 102 may be configured to cause the first graphical representation to move on the display from the first position to the second position. In some embodiments, the apparatus 102 may be configured to cause the first graphical representation to move from the first position to the second position with the user input. For example, in FIG. 7, the first graphical representation “G” 425 has been moved from the first position 421 toward the second position 422 with the user's finger 457 (e.g., along arrow 467).

To further aid in accurate placement of the first (e.g., selected) graphical representation, in some embodiments, the apparatus 102 may be configured to alter the displayed order of the graphical representations to provide a “preview” of the potential new order of graphical representations (e.g., once the moving of the first graphical representation would be finalized). In some embodiments, the apparatus 102 may be configured to cause at least one third graphical representation to move on the display. For example, the apparatus 102 may cause graphical representations to fill in positions left vacant by movement of other graphical representations (such as the now moved first graphical representation). Such filling in can be performed in an order based on the previous order. For example, with reference to FIG. 7, graphical representation “H” 473 may be moved to replace the previous position (e.g., the first position 421) of the first graphical representation 425. Then, graphical representation “I” 474 may be moved to fill the position that graphical representation “H” 473 left vacant. This process may continue until vacancy in the second position 425 is reached, such that the position previously filled by graphical representation “O” 472 (e.g., the second position 422) is now vacant and ready to receive the first graphical representation “G” 425.

As used herein, though example descriptions detail a third graphical representation, in some embodiments, the third graphical representation may be a second graphical representation for purposes of previous descriptive embodiments. For example, graphical representation “K” underwent a reduction in size (e.g., acted as a second graphical representation, shown in FIG. 6C) and underwent movement (e.g., acted as a third graphical representation, shown in FIG. 7).

Additionally, in some embodiments, the apparatus 102 may be configured to cause at least one third graphical representation to move on the display such that a space on the display appears where the first (e.g., selected) graphical representation is set to move to (e.g., the second position). In some embodiments, the apparatus 102 may be configured to move at least one of the at least one of the third graphical representations on the display out of the second position. Thus, the third graphical representation that moves out of the second position creates a space (e.g., void), thereby enabling visual identification by the user of the future placement of the first (e.g., selected) graphical representation. For example, FIG. 7 shows a space 465 defined between graphical representations “K”-“M”, “O”, “P”, and “R”-“T”. The space 465 was created by movement of graphical representation “O” 472 (e.g., a third graphical representation) out of the second position 422, which may occur as the first graphical representation “G” 425 is moved toward the second position 422.

In some embodiments, the apparatus 102 may be configured to alter the display of the graphical representations upon movement of the first graphical representation. In some embodiments, the apparatus 102 may be configured to cause alteration of (e.g., reduce, enlarge, etc.) the size of the at least one third graphical representation. Such altering of the displayed third graphical representations may be similar to that of the second graphical representations that were altered upon the first (e.g., initial) user input (shown in FIG. 6). Thus, the same alteration rules and embodiments (e.g., enlargement, reduction, amount of reduction, etc.) may be applied to the third graphical representations. For example, with reference to FIG. 7, once the user 450 moves the first graphical representation “G” 425 toward the second position 422, the apparatus 400 may cause an alteration in the size of the graphical representations “K”-“M”, “O”, “P”, and “R”-“T” 445″, which are directly adjacent to the second position 422, such that they become a first reduced size (e.g., smallest reduced size) in comparison to the first graphical representation “G” 425. Such alteration may be different (or, in some cases, non-existent) for each affected third graphical representation, as the size of each graphical representation may vary depending upon previous alterations by the apparatus. For example, graphical representation “L” may not change in size at all, as it was already reduced to its current size during the reduction performed in response to the first (e.g., initial) user input (shown in FIG. 6C). On the other hand, graphical representation “S” may be reduced, as it was not previously reduced in response to the first (e.g., initial) user input (shown in FIG. 6C).

Additionally, the apparatus 400 may cause a second alteration in the size of the graphical representations “E”-“I”, “J”, “N”, and “Q” 435″, which are a row or column further removed from the second position 422, such that they become a second reduced size (e.g., a slightly reduced size) in comparison to the first graphical representation “G” 425. Further, the apparatus 400 may cause a third alteration in the size of the graphical representations “A”-“D” 417′, which are outside of the minimum threshold distance from the second position 422, such that they become the original size (such as shown in FIG. 5). As noted above, in some circumstances, any of the above described alterations may not require any alteration (e.g., change) in the size of a specific graphical representation. In such circumstances, the graphical representation may already define a size that is equivalent to the target size, such that no alteration needs to be performed (e.g., see the example of graphical representation “L” above).

Such alteration to the size of the third graphical representations enables the size of the space (e.g., the void in the second position) to be enlarged such that is more discernable by the user (e.g., provides a larger target for easy placement of the first graphical representation). Additionally, the enlarged space enables a user to place the first graphical representation within a larger space, but still result in the desired positioning of the first graphical representation (e.g., allow for greater error in the user placement). In some embodiments, the alterations of the third graphical representations may cause the space to define a size at least as large as the first (e.g., selected) graphical representation. For example, with reference to FIG. 7A, the first graphical representation “G” 425 is shown, in its expanded state, completely within the space 465. Advantages of such an improved display allow for a user to more easily perform placement and positioning of the first (selected) graphical representation on the display.

Though the depicted embodiments illustrate a change in the display of the graphical representations after movement of the first graphical representation to the second position, in some embodiments, the apparatus 102 may be configured to alter display of the graphical representations as the first graphical representation is moved across the display (e.g., the second position is defined by the current location of the first graphical representation and, thus, the second position changes as the user input changes).

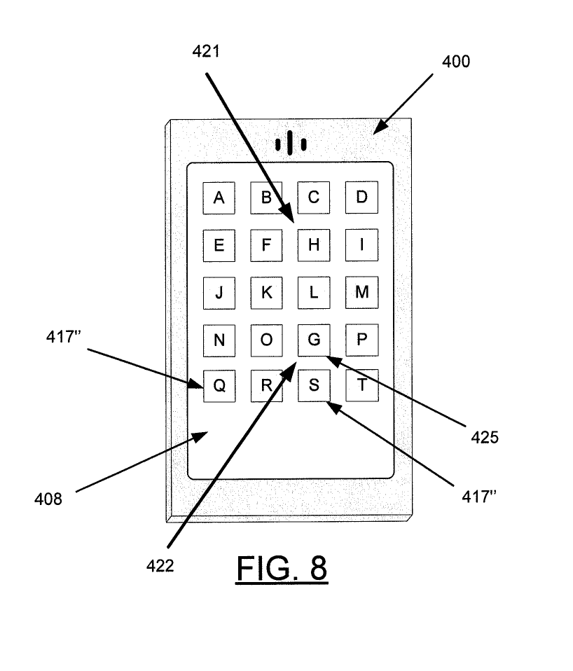

Once the user completes the second user input (e.g., drag/swipe gesture) such that the first graphical representation has been moved from the first position to the second position, the user may release the first (selected) graphical representation for positioning within the arrangement of the graphical representations on the display. In response to the user releasing the first graphical representation, the apparatus 102 may be configured to cause the graphical representations to return to their original sizes. For example, with reference to FIG. 8, the first graphical representation “G” 425 has been reduced from the enlarged size to the original size. Likewise, the remaining graphical representations “A”-“F” and “H”-“T” have been returned to their original size. Additionally, the order of the graphical representations accurately reflects the movement of the first graphical representation “G” from the first position 421 to the second position 422.

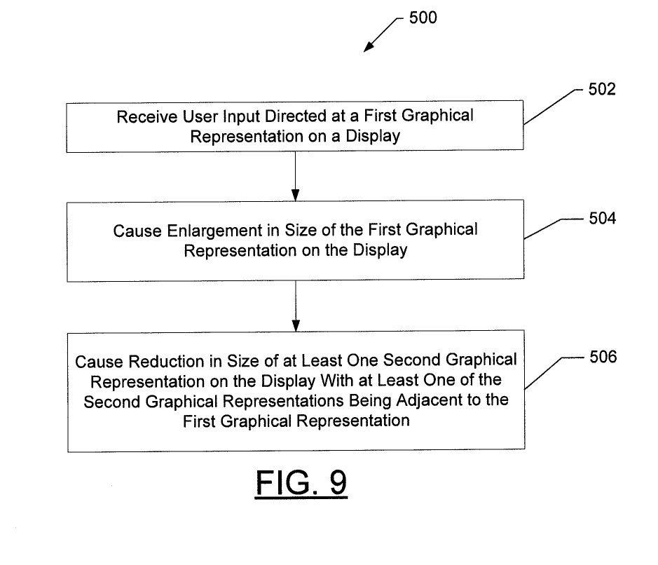

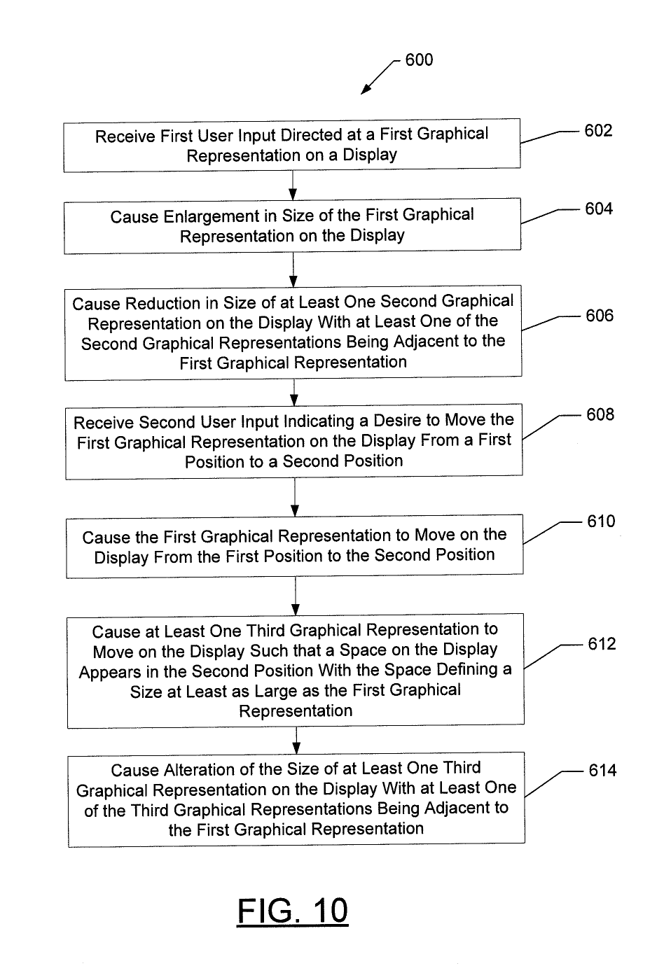

Embodiments of the present invention provide methods, apparatus and computer program products for improved display of graphical representations during reordering. Various examples of the operations performed in accordance with embodiments of the present invention will now be provided with reference to FIGS. 9-10.

FIG. 9 illustrates a flowchart according to an example method for improved display of graphical representations during reordering according to an example embodiment 500. The operations illustrated in and described with respect to FIG. 9 may, for example, be performed by, with the assistance of, and/or under the control of one or more of the processor 110, memory 112, communication interface 114, user interface 116, or UI control circuitry 122. Operation 502 may comprise receiving user input directed at a first graphical representation on a display. The processor 110, user interface 116, and/or UI control circuitry 122 may, for example, provide means for performing operation 502. Operation 504 may comprise causing enlargement in size of the first graphical representation on the display in response to receiving the user input. The processor 110, user interface 116, and/or UI control circuitry 122 may, for example, provide means for performing operation 504. Operation 506 may comprise causing reduction in size of at least one second graphical representation on the display in response to receiving the user input with at least one of the second graphical representations being adjacent to the first graphical representation. The processor 110, user interface 116, and/or UI control circuitry 122 may, for example, provide means for performing operation 506.

FIG. 10 illustrates a flowchart according to an example method for improved display of graphical representations during reordering according to an example embodiment 600. The operations illustrated in and described with respect to FIG. 10 may, for example, be performed by, with the assistance of, and/or under the control of one or more of the processor 110, memory 112, communication interface 114, user interface 116, or UI control circuitry 122. Operation 602 may comprise receiving user input directed at a first graphical representation on a display. The processor 110, user interface 116, and/or UI control circuitry 122 may, for example, provide means for performing operation 602. Operation 604 may comprise causing enlargement in size of the first graphical representation on the display in response to receiving the first user input. The processor 110, user interface 116, and/or UI control circuitry 122 may, for example, provide means for performing operation 604. Operation 606 may comprise causing reduction in size of at least one second graphical representation on the display in response to receiving the first user input with at least one of the second graphical representations being adjacent to the first graphical representation. The processor 110, user interface 116, and/or UI control circuitry 122 may, for example, provide means for performing operation 606.

Operation 608 may comprise receiving second user input indicating a desire to move the first graphical representation on the display from a first position to a second position. The processor 110, user interface 116, and/or UI control circuitry 122 may, for example, provide means for performing operation 608. Operation 610 may comprise causing the first graphical representation to move on the display from the first position to the second position in response to receiving the second user input. The processor 110, user interface 116, and/or UI control circuitry 122 may, for example, provide means for performing operation 610. Operation 612 may comprise causing at least one third graphical representation to move on the display in response to receiving the second user input such that a space on the display appears in the second position with the space defining a size at least as large as the first graphical representation. The processor 110, user interface 116, and/or UI control circuitry 122 may, for example, provide means for performing operation 612. Operation 614 may comprise causing alteration of the size of at least one third graphical representation on the display in response to receiving the second user input with at least one of the third graphical representations being adjacent to the first graphical representation. The processor 110, user interface 116, and/or UI control circuitry 122 may, for example, provide means for performing operation 614.

FIGS. 9-10 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving user input directed at a first graphical representation on a display;
causing, by a processor, enlargement in size of the first graphical representation on the display in response to receiving the user input; and
causing reduction in size of at least a second graphical representation on the display in response to receiving the user input, wherein at least one of the at least one second graphical representation is displayed adjacent to the first graphical representation.

2. The method according to claim 1 further comprising:
receiving second user input indicating a desire to move the first graphical representation on the display, wherein the second user input indicates a change in position of the first graphical representation from a first position to a second position on the display; and
causing the first graphical representation to move on the display from the first position to the second position in response to receiving the second user input.

3. The method according to claim 2 further comprising causing at least one third graphical representation to move on the display in response to receiving the second user input such that a space on the display appears in the second position, wherein at least one of the at least one third graphical representation is moved on the display out of the second position.

4. The method according to claim 3, wherein the space defines a size at least as large as the first graphical representation.

5. The method according to claim 3 further comprising causing alteration of the size of the at least one third graphical representation in response to receiving the second user input.

6. The method according to claim 5, wherein causing reduction in size of the at least one third graphical representation comprises reducing the size of the at least one third graphical representation an amount based at least in part on the inverse proportional distance on the display from the at least one third graphical representation to the space.

7. The method according to claim 1, wherein causing reduction in size of the at least one second graphical representation comprises reducing the size of the at least one second graphical representation an amount based at least in part on the inverse proportional distance on the display from the at least one second graphical representation to the first graphical representation.

8. The method according to claim 1, wherein the graphical representation corresponds to at least one of an application, a media file, a document, or picture.

9. An apparatus comprising a processor and a memory including computer program code, the memory and the computer program code configured to, with the processor, cause the apparatus to:
receive user input directed at a first graphical representation on a display;
cause enlargement in size of the first graphical representation on the display in response to receiving the user input; and
cause reduction in size of at least a second graphical representation on the display in response to receiving the user input, wherein at least one of the at least one second graphical representation is displayed adjacent to the first graphical representation.

10. The apparatus of claim 9, wherein the memory and the computer program code are further configured to, with the processor, cause the apparatus to:
receive second user input indicating a desire to move the first graphical representation on the display, wherein the second user input indicates a change in position of the first graphical representation from a first position to a second position on the display; and
cause the first graphical representation to move on the display from the first position to the second position in response to receiving the second user input.

11. The apparatus according to claim 10, wherein the memory and the computer program code are further configured to, with the processor, cause the apparatus to cause at least one third graphical representation to move on the display in response to receiving the second user input such that a space on the display appears in the second position, wherein at least one of the at least one third graphical representation is moved on the display out of the second position.

12. The apparatus according to claim 11, wherein the space defines a size at least as large as the first graphical representation.

13. The apparatus according to claim 11, wherein the memory and the computer program code are further configured to, with the processor, cause the apparatus to cause alteration of the size of the at least one third graphical representation in response to receiving the second user input.

14. The apparatus according to claim 13, wherein the memory and the computer program code are further configured to, with the processor, cause the apparatus to cause reduction in size of the at least one third graphical representation by reducing the size of the at least one third graphical representation an amount based at least in part on the inverse proportional distance on the display from the at least one third graphical representation to the space.

15. The apparatus according to claim 9, wherein the memory and the computer program code are further configured to, with the processor, cause the apparatus to cause reduction in size of the at least one second graphical representation by reducing the size of the at least one second graphical representation an amount based at least in part on the inverse proportional distance on the display from the at least one second graphical representation to the first graphical representation.

16. Computer program product comprising a non-transitory computer readable medium having program code portions means stored thereon, the program code portions being a computer readable medium and configured when said program product is run on a computer or network device, to:
receive user input directed at a first graphical representation on a display;
cause enlargement in size of the first graphical representation on the display in response to receiving the user input; and
cause reduction in size of at least a second graphical representation on the display in response to receiving the user input, wherein at least one of the at least one second graphical representation is displayed adjacent to the first graphical representation.

17. The computer program product of claim 16, wherein the program code portions are further configured when said program product is run on a computer or network device, to:
receive second user input indicating a desire to move the first graphical representation on the display, wherein the second user input indicates a change in position of the first graphical representation from a first position to a second position on the display; and
cause the first graphical representation to move on the display from the first position to the second position in response to receiving the second user input.

18. The computer program product of claim 17, wherein the program code portions are further configured when said program product is run on a computer or network device, to cause at least one third graphical representation to move on the display in response to receiving the second user input such that a space on the display appears in the second position, wherein at least one of the at least one third graphical representation is moved on the display out of the second position.

19. The computer program product of claim 18, wherein the space defines a size at least as large as the first graphical representation.

20. The computer program product of claim 18, wherein the program code portions are further configured when said program product is run on a computer or network device, to cause alteration in size of the at least one third graphical representation in response to receiving the second user input.
